(19) United States
(12) Patent Application Publication
(10) Pub. No.: US 2007/0091051 A1
(43) Pub. Date: Apr. 26, 2007

(54) Data driver, apparatus and method for reducing power on current thereof

(76) Inventor: Wan Hsiang Shen, Taipei City (TW)

Correspondence Address: J.C. Patents, Inc.;Suite 250, 4 Venture, Irvine, CA, 92618, US

(21) Appl. No.: 11/329,689

(22) Filed: Jan. 10, 2006

(30) Foreign Application Priority Data
Oct. 25, 2005 (TW) 94137243

(51) Int. Cl. G09G 3/36

(52) U.S. Cl. 345/100

(57) ABSTRACT

A data driver, an apparatus and a method for reducing power on current thereof are disclosed. The invention is used to reduce the start-up current for the data driver. The data driver includes a high-voltage output circuit. The method comprises at least following steps. First, receiving a charge-sharing enable signal and a data-transfer signal, the data-transfer signal includes a plurality of data-transfer enable signals generated in sequence. There exists an interval between two adjacent data-transfer enable signals. After the charge-sharing enable signal has received at least an interval, a delay charge-sharing enable signal is output. After voltage-level shifted, the voltage of the charge-sharing enable signal is then output as the high-voltage charge-sharing enable signal to start the high-voltage output circuit.

### CROSS-REFERENCE TO RELATED APPLICATION

This application claims the priority benefit of Taiwan application serial no. 94137243, filed on Oct. 25, 2005. All disclosure of the Taiwan application is incorporated herein by reference.

### BACKGROUND OF THE INVENTION

1. Field of Invention

The present invention relates to an apparatus of driving a flat panel display and the method thereof. More specifically, the present invention relates to a data driver, the apparatus of reducing the starting-up current of the data driver and the method thereof.

2. Description of Related Art

The flat panel display, for example liquid crystal display (LCD) has been widely used recently. Along with advance of semi-conductive manufacturing technology, the LCD is characterized with advantages of low power consumption, thin, light weight, high resolution, high color saturation and long life span. Therefore LCD is widely used on daily electronics like the LCD monitors of notebook computers or desktop computers and LCD TVs, and etc. Wherein, the data driver of display is an indispensable component for LCD.

FIG. 1A is a schematic circuit block diagram of a data driver used in a conventional LCD. With reference to FIG. 1A, the data driver comprises a low-voltage circuit 10 and a high-voltage circuit 11. Wherein, the low-voltage circuit includes a shift register 100 and a memory circuit 102. The high-voltage circuit 11 comprises a first voltage level shifter 110, a digital-analog converter 112 and an output buffer 114. The shift buffer 100 receives a start pulse SP, clock signals CLK and serial digital display data SDATA. When the start pulse SP is received, the shift register 100 starts to receive the serial digital display data SDATA according to a clock signal. Before the receiving of a next start pulse SP, the serial digital display data SDATA is output as the parallel digital display data PDATA to the memory circuit 102. After the memory circuit 102 receives a data-transfer signal LS, the parallel digital display data PDATA is then output to the voltage level shifter 110 by the memory circuit 102.

After the parallel digital display data PDATA output by the memory circuit 102 is shifted from a low-voltage level to a high-voltage level by the voltage level shifter 110, a high-voltage parallel digital display data HVPDATA is output to the digital-to-analog converter 112. After the digital-analog converter 112 converts the high-voltage parallel digital display data HVPDATA into an analog display data ADATA, the analog display data ADATA is then sent to an output buffer 114. Eventually, the output buffer 114 outputs the analog display data ADATA and provides an extra driving power for driving the LCD panel.

FIG. 1B shows an operation frequency timing chart of a data driver used in the conventional LCD shown in FIG. 1A. With reference to FIG. 1B, as shown in FIG. 1B, from the starting and prior to the inputting of the first data-transfer signal LS, the low-voltage circuit 10 has no output at all. However, the high-voltage circuit 11 is still in action, so that from the starting period and prior to the inputting of the first data-transfer signal LS is input, the high-voltage circuit 11 may output an unknown data UDATA. When the power is just turned on, since there is no charge stored in each of the pixels of the LCD panel, there may be a strong current to charge the LCD panel in the data driver during the starting-up period. The power consumption is thus generated. Moreover, since a strong current is required to charge the LCD panel when the power is turned on, this requires the driver circuit and the power supply circuit to have to provide a strong current, a larger integrated circuit layout area is necessitated.

### SUMMARY OF THE INVENTION

The object of the present invention is to provide a data driver used to reduce the unnecessary power consumption during the starting up period.

Another object of the present invention is to provide an apparatus for reducing starting-up current capable of reducing the unnecessary start-up current of the data driver.

Another object of the present invention is to provide a method for reducing starting-up current capable of reducing the unnecessary power consumption of the data driver and the panel system when the data driver and the panel system start.

The present invention provides an apparatus for reducing starting-up current capable of reducing capable of reducing the output current when the data driver is started. The data driver comprises a high-voltage output circuit. The apparatus has a delay circuit and a logic circuit. The delay circuit is used to receive a charge-sharing enable signal and a data-transfer signal. The data-transfer signal includes a plurality of data-transfer enable signals generated in sequence. There is an interval between two adjacent data-transfer enable signals. After the charge-sharing enable signal is received for at least an interval, the delay circuit starts to output a delay charge-sharing enable signal and the data-transfer enable signals. The logic circuit executes a logic operation of the delay charge-sharing enable signal generated by the delay circuit and the data-transfer enable signals and then outputs a control signal for starting the high-voltage output circuit.

The present invention provides a data driver used to drive the LCD panel. The data driver comprises a data processing circuit, a first voltage level shifter, a digital-to-analog converter, an output buffer and a start-up current reduction apparatus. The start-up current reduction apparatus is used to receive a charge-sharing enable signal and a data-transfer signal. The data-transfer signal includes a plurality of data-transfer enable signals generated in sequence. There is an interval between two adjacent enable signals. After the charge-sharing enable signal has received for at least an interval, the starting-up current reduction apparatus starts to output a control signal according to the charge-sharing enable signal and the data-transfer enable signals. The data processing circuit is used to temporally store a display data, and outputs the display data when the data-transfer enable signal is received. The first voltage level shifter is used to convert the display data into a first voltage level display data. The digital-to-analog converter is used to convert the first voltage level display data into the analog display data. The output buffer receives the control signal and the analog display data. When the received control signal is enabled, the analog display data is used to drive the LCD panel.

The present invention provides a start-up current reduction method for reducing the output current when the data driver is started. The data driver comprises a high-voltage output circuit. The start-up current reduction method comprises at least the following steps. First, a charge-sharing enable signal and a data-transfer signal are received, wherein the data-transfer signal includes a plurality of data-transfer enable signals generated in sequence and there is an interval between the adjacent data-transfer enable signals. After the charge-sharing enable signal starts to have been received for at least an interval, a delay charge-sharing enable signal is output. The voltage of the charge-sharing enable signal is voltage-level-shifted, and then is output as a high-voltage charge-sharing enable signal for starting the high-voltage output circuit.

As the present invention utilizes the apparatus of reducing the start-up current of the data driver, the high-voltage output circuit within the data driver is shut-off when the panel system is started, so that there is no strong current for charging the LCD panel when the panel system is started. Therefore the panel system start-up current and the power consumption can be reduced.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

FIG. 1A is a schematic circuit block diagram of a data driver used in a conventional LCD.

FIG. 1B is a operation timing chart of the data driver used in the conventional LCD in FIG. 1A.

FIG. 2 is a schematic circuit block diagram of the data driver of the embodiment of the present invention.

FIG. 3 is a schematic detail circuit diagram of the starting-up current reduction apparatus of the embodiment of the present invention.

FIG. 4 is a operation timing chart of the circuit in FIG. 3 of the embodiment of the present invention.

FIG. 5 schematically illustrates an implementation circuit of the output buffer in the data driver of the embodiment of the present invention.

### DESCRIPTION OF EMBODIMENTS

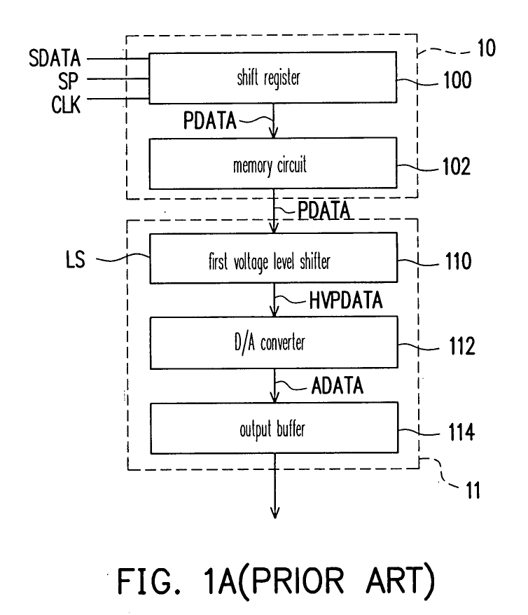

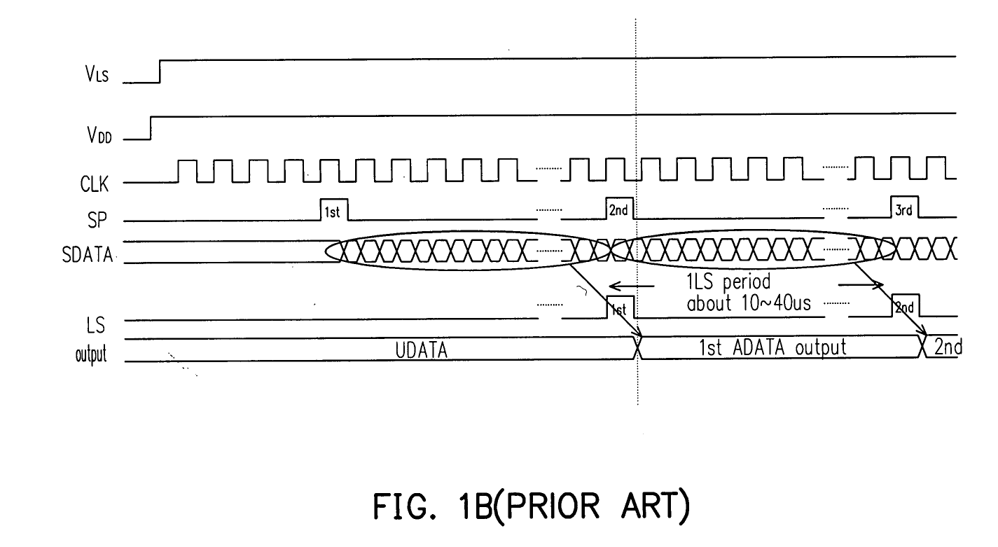

As the conventional technology may have such a consequence as shown in FIG. 1B so that there is a relatively stronger starting-up current and larger power consumption during the starting-up, the following embodiment of the present invention is to overcome the conventional shortcoming.

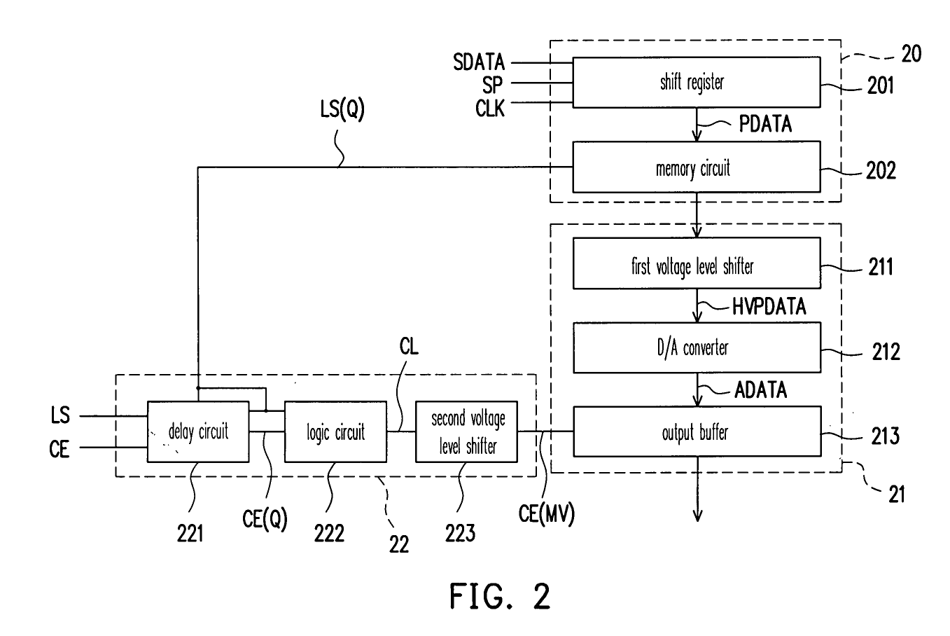

FIG. 2 is a schematic circuit block diagram of the data driver of the embodiment of the present invention. With reference to FIG. 2, the data driver comprises a data processing circuit 20, a high-voltage output circuit 21 and a starting-up current reduction apparatus 22. Wherein, the data processing circuit 20 comprises a shift buffer 201 and a memory circuit 202. The high-voltage output circuit 21 comprises a first voltage level shifter 211, a digital-to-analog converter 212 and an output buffer 213. The starting-up current reduction apparatus 22 comprises a delay circuit 221, a logic circuit 222 and a second voltage level shifter 223.

First, the shifter buffer 201 in the data processing circuit 20 receives a start pulse SP, clock signal CLK and serial digital display data SDATA. When the start pulse SP is received, the shift buffer 201 starts to receive serial digital display data SDATA according to the clock signal. Before the receiving of the next start pulse SP, the serial digital display data SDATA is output to the memory circuit 202 as parallel digital display data PDATA. When the memory circuit 202 receives the data-transfer enable signal LS(Q) output from the delay circuit in the starting-up current reduction apparatus 22, then the parallel digital display data PDATA is output to the first voltage level shifter 211 in the high-voltage output circuit 21.

After the first voltage level shifter 211 converts the parallel digital display data PDATA output by the memory circuit 202 into a first voltage level (for example high-voltage 15V level) from a digital logic level (for example 3.3V), then the parallel digital display data HVPDATA of the high-voltage 15V level is output to the digital-to-analog converter 212. After the digital-to-analog converter 212 converts the parallel digital display data HVPDATA with a high-voltage 15V level into analog display data ADATA, the analog display data ADATA is sent to the output buffer 213. After the output buffer 213 receives a high-voltage charge-sharing enable signal CE (MV), the analog display data ADATA is output, and an extra driving power is provided to drive the LCD panel to display images.

The starting-up current reduction apparatus 22 receives the charge-sharing enable signal CE and the data-transfer signal LS. The data-transfer signal LS includes a plurality of charge-sharing enable signals generated in sequence. There is an interval (a horizontal scan period) between these two adjacent enable signals. The starting-up current reduction apparatus 22 receives the charge-sharing enable signal, and then starts to output the charge-sharing enable signal CE(Q) and the data-transfer enable signal LS(Q) after, for example, two horizontal scan periods. After that, the voltage of the charge-sharing enable signal CE(Q) is voltage-level-shifted and then output as a high-voltage charge-sharing enable signal CE(MV) for starting the output buffer 213 (the present embodiment adopts two horizontal scan periods. It is well known for those who are skill in the art, that it can be implemented simply using at least one horizontal scan period) in the high-voltage output circuit 21.

Wherein, the delay circuit 221 in the starting-up current reduction apparatus 22 is used to receive the data-transfer enable signal LS and the charge-sharing enable signal CE, and to delay the data-transfer enable signal LS and the charge-sharing enable signal CE for two horizontal scan periods, and then to output a control signal to control the high-voltage output circuit 21 according to the charge-sharing enable signal and the data-transfer enable signal.

The charge-sharing enable signal CE(Q) output by the delay circuit 221 and the data-transfer enable signal LS(Q) output by the delay circuit 221 are performed a logic operation by a logic circuit 222, and are then output as the control signal CL. The second voltage level shifter 223 receives the control signal CL output by the logic circuit 222, and then performs a voltage level shifting for the control signal CL with its voltage being elevated to the 15V level, and then outputs the control signal CL as the high-voltage charge-sharing enable signal CE(MV) for starting the output buffer 213 in the high-voltage output circuit 21.

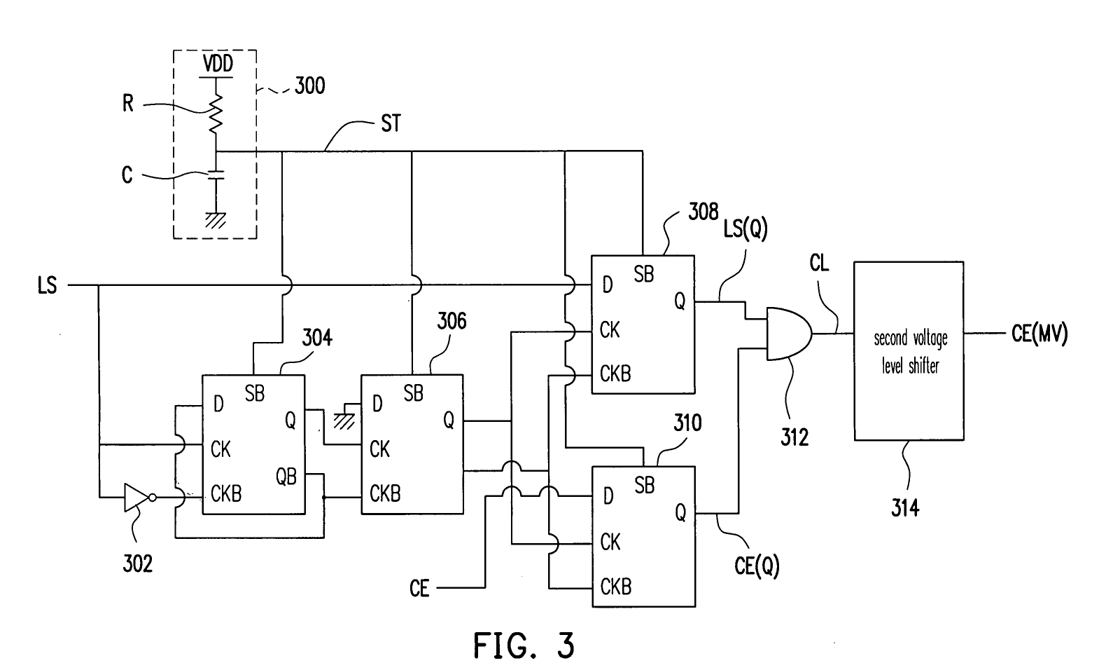

FIG. 3 is a schematic detail circuit diagram of the starting-up current reduction apparatus of an embodiment of the present invention. With reference to FIG. 3, the circuit comprises a start-up resetting circuit 300, an inverter 302, a first D flip-flop 304, a second D flip-flop 306, a third D flip-flop 308, a fourth D flip-flop 310, an AND logic gate 312 and a second voltage level shifter 314. Wherein, the inverter 302, the first D flip-flop 304, the second D flip-flop 306, the third D flip-flop 308 and the fourth D flip-flop 310 form the delay circuit 221 an embodiment of as shown in FIG. 2. The AND logic gate 312 is the logic circuit 222 an embodiment of as shown in FIG. 2.

Wherein, the start-up resetting circuit 300 is used to generate a setting signal ST, for example logic high voltage during the starting-up. The start-up resetting circuit 300 can have a resistor R and a charge storing component C. Wherein one end of the resistor R is coupled to a first potential, for example a power supply potential VDD. While one end of the charge storing component C is coupled to another end of the resistor R. Another end of the charge storing component C is coupled to a second potential, for example grounding. The logic high voltage setting signal ST is generated at the node where the resistor R and the charge storing component C are coupled.

The input end of the inverter 302 receives the data-transfer signal LS, and the data-transfer signal LS is logically inverted and then is output. The first D flip-flop 304 comprises a setting terminal SB, a positive clock input terminal CK, an inverse clock input terminal CKB, a D input terminal D, a positive output terminal Q and an inverse output terminal QB. The setting terminal SB of the first D flip-flop 304 receives the setting signal ST. The positive clock input terminal CK of the first D flip-flop 304 receives the data-transfer signal LS. The inverse clock input terminal CKB of the first D flip-flop 304 is coupled to the output terminal of the inverter 302. The D input terminal D of the first D flip-flop 304 is coupled to the inverse input terminal QB of the first D flip-flop 304.

The second D flip-flop 306 comprises the setting terminal SB, the positive clock input terminal CK, the inverse clock input terminal CKB, the D input terminal D, the positive output terminal Q and the inverse output terminal QB. The setting terminal SB of the second D flip-flop 306 receives the setting signal ST. The positive clock input terminal CK of the second D flip-flop 306 is coupled to the positive output terminal Q of the first D flip-flop 304. The inverse clock input terminal CKB of the second D flip-flop 306 is coupled to the inverse output terminal QB of the first D flip-flop 304. The D input terminal D of the second D flip-flop 306 inputs a logic 0 level, for example, a ground level.

The third D flip-flop 308 comprises the setting terminal SB, the positive clock input terminal CK, the inverse clock input terminal CKB, the D input terminal D and the output terminal Q. The setting terminal SB of the third D flip-flop 308 receives the setting signal ST. The positive clock input terminal CK of the third D flip-flop 308 is coupled to the positive output terminal Q of the second D flip-flop 306. The inverse clock input terminal CKB of the third D flip-flop 308 is coupled to the inverse output terminal QB of the second D flip-flop 306. The D input terminal of the third D flip-flop 308 receives the data-transfer signal LS. The output terminal of the third D flip-flop 308 outputs the data-transfer enable signal LS(Q).

The fourth D flip-flop 310 includes the setting terminal SB, the positive clock input terminal CK, the inverse clock input terminal CKB, the D input terminal D and the output terminal Q. The setting terminal SB of the fourth D flip-flop 310 receives the setting signal ST. The positive clock input terminal CK of the fourth D flip-flop 310 is coupled to the positive output terminal Q of the second D flip-flop 306. The inverse clock input terminal CKB of the fourth D flip-flop 310 is coupled to the inverse output terminal QB of the second D flip-flop 306. The D input terminal D of the fourth D flip-flop 310 receives the charge-sharing enable signal CE. The output terminal Q of the fourth D flip-flop 310 outputs the delay charge-sharing enable signal CE(Q).

The AND logic gate 312 applies an AND logic operation to the charge-sharing enable signal CE(Q) and the data-transfer enable signal LS(Q), which are output by the delay circuit described above, and then the control signal CL is output. Eventually, the second voltage level shifter 314 voltage-level-shifts the logic level output by the AND logic gate 312 to a high-voltage 15V level, and then the high-voltage charge-sharing enable signal CE(MV) is output to start the output buffer 213 in the high-voltage circuit.

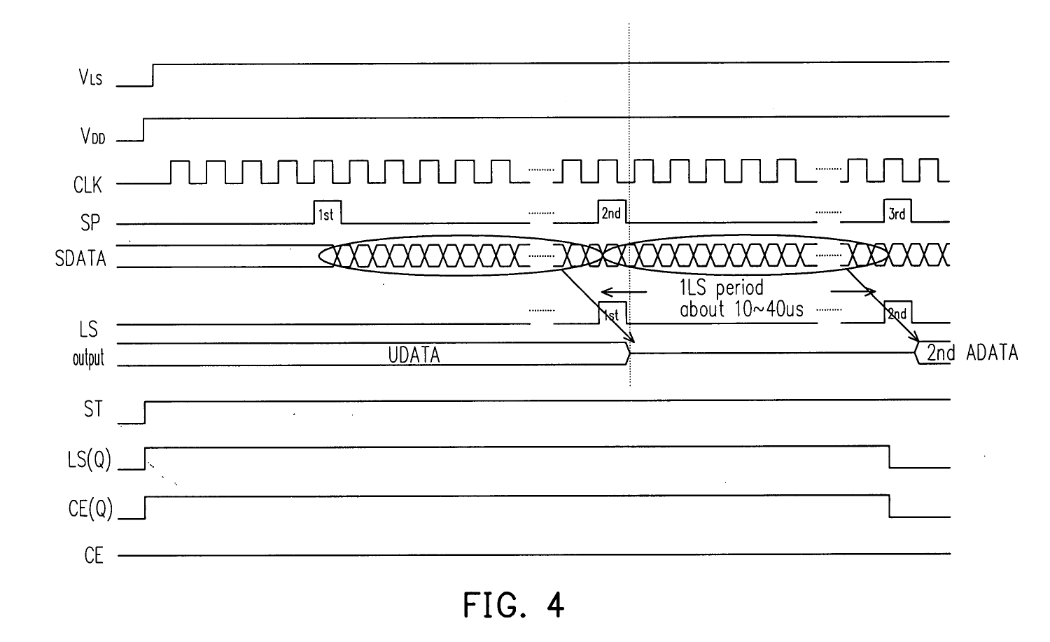

FIG. 4 is a schematic operation timing chart of the circuit shown in FIG. 3 of the embodiment of the present invention. With reference to FIG. 3 and FIG. 4, as shown in FIG. 4, when the circuit in FIG. 3 is started, the start-up resetting circuit 300 generates the setting signal ST with a logic high level, and the outputs of all D flip-flops are set to a logic high level. Furthermore, the circuit uses the pulse in the data-transfer signal LS, i.e. the data-transfer enable signal, as the clock signal. After a delay of two horizontal scan periods (two pulses periods), the data-transfer enable signal LS(Q) output by the third D flip-flop 308 will be equal to the data-transfer signal LS. The charge-sharing enable signal CE is assumed to be originally set to a logic low level during the starting-up. After a delay of two data-transfer signals LS, the charge-sharing enable signal CE(Q) output by the fourth D flip-flop 310 is then pulled down to a logic low level. Eventually, the second voltage level shifter 314 outputs the high-voltage charge-sharing enable signal CE(MV) with a logic low level to start the output buffer 213, so as to output the second scan line (as shown as 2^{nd} ADATA in the figure) of a first frame.

It can be easily seen from two timing charts of FIG. 1B and FIG. 4, since the embodiment of the present invention adds a start-up current reduction apparatus into the data driver, the first scan line (marked 1^{st} ADATA in the drawing) of the first frame originally in FIG. 1B is not shown. As during the period where the LCD panel is just started, there is no electric charge stored in every pixel. If the LCD panel is charged at this moment, the data driver may have a very large current load during the starting-up period. However, the first frame is omitted in the embodiment of the present invention, therefore the starting-up current consumption is reduced, and meanwhile the unnecessary large current load on the data driver during the starting-up period is also reduced.

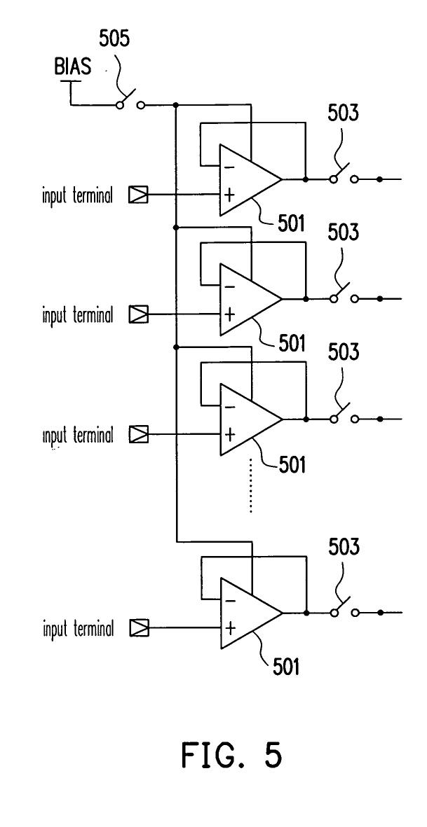

FIG. 5 schematically illustrates an implementation circuit of the output buffer in the data driver of the embodiment of the present invention. With reference to FIG. 5, the output buffer includes a plurality of single gain amplifiers 501, a plurality of first switches 503 and a second switch 505. Each of the single gain amplifiers 501 comprises an input terminal an output terminal. The input terminal receives the analog display data ADATA. Each of the first switches 503 respectively is coupled to the output terminal of each of the single gain amplifiers 501. Wherein when the high-voltage charge-sharing enable signal CE(MV) is enabled (for example when it is at logic-low potential), all of the first switches 501 are turned on. One terminal of the second switch 505 is coupled to the first bias, and another terminal of the second switch 505 is coupled to the start-up terminal of the single gain amplifier 501. Wherein when the high-voltage charge-sharing enable signal CE(Q) is enabled (for example when it is at a logic low level), the second switch 505 is turned on to start the single gain amplifier 501.

With reference to FIG. 4 and FIG. 5, when the data driver is started, since the delay charge-sharing enable signal CE(Q) is pulled high to a logic high level, which causes the first switches 503 and the second switch 505 to be cut-off. Therefore, the error data will not be output to the panel until two data-transfer signal LS periods elapse, the delay charge-sharing enable signal CE(Q) is pull down to a logic low level, so that the first switches and the second switch of the output buffer are turned on.

In addition, in the present invention, even though the previous two data-transfer signals LS are delayed (omitted), which results in the disappearance of the previous two scan lines from the frame when starting up. However, it is only the first and the second scan line of the first display frame. For a display with 60 frames/second, the disappearance of the first and the second scan lines of the first frame is hardly perceived by human eyes.

Bases on the above embodiment, the embodiment can be concluded as a start-up current reduction method of a data driver capable of reducing the output current when the data driver is started. The data driver includes a high-voltage output circuit. The method includes the following steps. First, the charge-sharing enable signal CE and the data-transfer signal LS are received. The data-transfer signal LS includes a plurality of data-transfer enable signals generated in sequence. There is a horizontal scan period interval between two adjacent data-transfer enable signals. After 1 the charge-sharing enable signal has begun to have received for at least a horizontal scan period interval, the delay charge-sharing enable signal CE(Q) and the data-transfer enable signal LS(Q) are output. The voltage of the delay charge-sharing enable signal CE(Q) is voltage-level-shifted and then output as a high-voltage charge-sharing enable signal CE(MV) to start the high-voltage output circuit. And the data-transfer enable signal LS(Q) is used to start the low-voltage circuit in the data driver.

To summarize, since the present invention adopts the apparatus of reducing the start-up current of the data driver, the high-voltage output circuit in the data driver is turned off during the starting-up, so that there is no strong current to charge the LCD panel during the starting-up. Therefore the starting-up current and the power consumption can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A data driver, used to drive an LCD panel, comprising:
a starting-up current reduction apparatus, used to receive a charge-sharing enable signal and a data-transfer signal, wherein the data-transfer signal comprises a plurality of data-transfer enable signals generated in sequence, an interval exists between two adjacent data-transfer enable signals and the starting-up current reduction apparatus has received the charge-sharing enable signal for at least an interval and then outputs a control signal according to the charge-sharing enable signal and the data-transfer enable signal;
a data processing circuit, used to temporally store a display data and to output the display data when receiving the data transfer enable data;
a first voltage level shifter, used to convert the display data into a first voltage level display data;
a digital-to-analog converter, used to convert the first voltage level display data into an analog display data; and
an output buffer, used to receive the control signal and the analog display data output by the starting-up current reduction apparatus, and when the received control signal output by the starting-up current reduction apparatus is enabled, the analog display data being used to drive the LCD panel.

2. The data driver as claimed in claim 1, wherein the starting-up current reduction apparatus comprises:
a delay circuit, used to receive the data-transfer enable signal and the charge-sharing enable signal, and to delay the data-transfer enable signal and the charge-sharing enable signal for at least a period of the interval and then to start to output a delay charge-sharing enable signal and the data-transfer enable signal; and
a logic circuit, used to apply a logic operation to the delay charge-sharing enable signal and the data-transfer enable signal output by the delay circuit and to output the control signal for controlling the output buffer.

3. The data driver as claimed in claim 2, wherein the starting-up current reduction apparatus further comprises:
a second voltage level shifter, receiving and voltage-level-shifting the control signal as well as then outputting a high-voltage charge-sharing enable signal to start the output buffer.

4. The data driver as claimed in claim 1, wherein the output buffer comprises:
a plurality of single gain amplifiers, each of which comprises an input terminal and an output terminal, as well as the input terminal receives the analog display data; and
a plurality of first switches, each of which is respectively coupled to the output terminal of each of these single gain amplifiers,
wherein these first switches are turned on when the control signal is enabled.

5. The data driver as claimed in claim 4, wherein the output buffer further comprises:
a second switch, one terminal of which is coupled to a first bias and another terminal is coupled to start-up terminals of these single gain amplifiers,
wherein the second switch is turned on to start these single gain amplifiers when the control signal is enabled.

6. The data driver as claimed in claim 2, wherein the delay circuit comprises:
an inverter, comprising an input terminal and an output terminal, the input terminal receiving the data-transfer enable signal and applying a logic inversion to the data-transfer enable signal and then outputting the inverted data-transfer enable signal;
a first D flip-flop, comprising a setting terminal, a positive clock input terminal,
an inverse clock input terminal, a D input terminal, a positive output terminal and an inverse output terminal, the setting terminal of the first D flip-flop receiving a setting signal, the positive clock input terminal of the first D flip-flop receiving the data transfer signal, the inverse clock input terminal of the first D flip-flop being coupled to the output terminal of the inverter and the D input terminal of the first D flip-flop being coupled to the inverse output terminal of the first D flip-flop;
a second first D flip-flop, comprising the setting terminal, the positive clock input terminal, the inverse clock input terminal, the D input terminal, the positive output terminal and the inverse output terminal, the setting terminal of the second D flip-flop receiving the setting signal, the positive clock input terminal of the second D flip-flop being coupled to the positive output terminal of the first D flip-flop, the inverse clock input terminal of the second D flip-flop being coupled to the inverse output terminal of the first D flip-flop and the D input terminal of the second D flip-flop inputting a logic 0 potential;
a third D flip-flop, comprising the setting terminal, the positive clock input terminal, the inverse clock input terminal, the D input terminal and the output terminal, the setting terminal of the third D flip-flop receiving the setting signal, the positive clock input terminal of the third D flip-flop being coupled to the positive output terminal of the second D flip-flop, the inverse clock input terminal of the third D flip-flop being coupled to the inverse output terminal of the second D flip-flop, the D input terminal of the third D flip-flop receiving the data-transfer enable signal and the output terminal of the third D flip-flop outputting the data-transfer enable signal; and
a fourth D flip-flop, comprising the setting terminal, the positive clock input terminal, the inverse clock input terminal, the D input terminal and the output terminal, the setting terminal of the fourth D flip-flop receiving the setting signal, the positive clock input terminal of the fourth D flip-flop being coupled to the positive output terminal of the second D flip-flop, inverse clock input terminal of the fourth D flip-flop being coupled to the inverse output terminal of the second D flip-flop, the D input terminal of the fourth D flip-flop receiving the charge-sharing enable signal and the output terminal of the fourth D flip-flop outputting the delay charge-sharing enable signal.

7. The data driver as claimed in claim 6, wherein the delay circuit further comprises:
a starting-up resetting circuit, used to generate the setting signal when starting up.

8. The data driver as claimed in claim 7, wherein the starting-up resetting circuit comprises:
a resistor, one terminal of the resistor being coupled to a first potential; and
a charge storing element, one terminal of the charge storing element being coupled to another terminal of the resistor, another terminal of the charge storing component being coupled to a second potential,
wherein the node where the resistor and the charge storing component are coupled generates the setting signal.

9. The data driver as claimed in claim 8, wherein the first potential is a power supply potential and the second potential is the ground potential.

10. The data driver as claimed in claim 2, wherein the logic circuit comprising:
an AND logic gate, used to apply an AND logic operation to the delay charge-sharing enable signal and the data-transfer enable signal output by the delay circuit and to output the control signal.

11. A starting-up current reduction apparatus, used to reduce the output current when the data driver being started, the data driver comprising a high-voltage output circuit, the starting-up current reduction apparatus comprising:
a delay circuit, used to receive a charge-sharing enable signal and a data-transfer signal, and the data-transfer signal comprising a plurality of data-transfer enable signals generated in sequence, an interval existing between the two adjacent enable signals, the delay circuit receiving the charge-sharing enable signal, and then after at least an period of the interval, the delay circuit starting to output a delay charge-sharing enable signal and the data-transfer enable signals;
a logic circuit, used to apply a logic operation to the charge-sharing enable signal output by the delay circuit and the data-transfer enable signal output by the delay circuit and to output a control signal to start the high-voltage output circuit.

12. The starting-up current reduction apparatus as claimed in claim 11, wherein the delay circuit comprises:
an inverter, comprising the input terminal and the output terminal, the input terminal receiving the data-transfer enable signal, and applying a logic inversion to the data-transfer enable signal and then outputting the inverted data-transfer enable signal;
a first D flip-flop, comprising the setting terminal, the positive clock input terminal, the inverse clock input terminal, the D input terminal, the positive output terminal and the inverse output terminal, the setting terminal of the first D flip-flop receiving a setting signal, the positive clock input terminal of the first D flip-flop receiving the data transfer enable signal, the inverse clock input terminal of the first D flip-flop being coupled to the output terminal of the inverter and the D input terminal of the first D flip-flop being coupled to the inverse output terminal of the first D flip-flop;
a second first D flip-flop, comprising the setting terminal, the positive clock input terminal, the inverse clock input terminal, the D input terminal, the positive output terminal and the inverse output terminal, the setting terminal of the second D flip-flop receiving the setting signal, the positive clock input terminal of the second D flip-flop being coupled to the positive output terminal of the first D flip-flop, the inverse clock input terminal of the second D flip-flop being coupled to the inverse output terminal of the first D flip-flop and the D input terminal of the second D flip-flop inputting a logic 0 potential;
a third D flip-flop, comprising the setting terminal, the positive clock input terminal, the inverse clock input terminal, the D input terminal and the output terminal, the setting terminal of the third D flip-flop receiving the setting signal, the positive clock input terminal of the third D flip-flop being coupled to the positive output terminal of the second D flip-flop, the inverse clock input terminal of the third D flip-flop being coupled to the inverse output terminal of the second D flip-flop, the D input terminal of the third D flip-flop receiving the data-transfer enable signal and the output terminal of the third D flip-flop outputting the data-transfer enable signal; and
a fourth D flip-flop, comprising the setting terminal, the positive clock input terminal, the inverse clock input terminal, the D input terminal and the output terminal, the setting terminal of the fourth D flip-flop receiving the setting signal, the positive clock input terminal of the fourth D flip-flop being coupled to the positive output terminal of the second D flip-flop, the inverse clock input terminal of the fourth D flip-flop being coupled to the inverse output terminal of the second D flip-flop, the D input terminal of the fourth D flip-flop receiving the charge-sharing enable signal and the output terminal of the fourth D flip-flop outputting the delay charge-sharing enable signal.

13. The starting-up current reduction apparatus as claimed in claim 12, wherein the delay circuit further comprises:
a starting-up resetting circuit, used to generate the setting signal when starting up.

14. The starting-up current reduction apparatus as claimed in claim 13, wherein the start-up resetting circuit comprises:
a resistor, one terminal of the resistor being coupled to a first potential; and
a charge storing element, one terminal of the charge storing element being coupled to another terminal of the resistor and another terminal of the charge storing element being coupled to a second potential,
wherein the node where the resistor and the charge storing component are coupled generates the setting signal.

15. The starting-up current reduction apparatus as claimed in claim 14, wherein the first potential is power supply potential and the second potential is a ground potential.

16. The starting-up current reduction apparatus as claimed in claim 11, wherein the logic circuit comprising:
an AND logic gate, used to apply an AND logic operation to the charge-sharing enable signal output by the delay circuit and the data-transfer enable signal output by the delay circuit and to output the control signal.

17. The starting-up current reduction apparatus as claimed in claim 11, further comprises:
a voltage level shifter, receiving the output of the logic circuit, and voltage-level-shifting as well as then outputting a high-voltage charge-sharing enable signal to start the high-voltage output circuit.

18. A data driver starting-up current reduction method, used to reduce the output current when the data driver being started, the data driver comprising a high-voltage output circuit, the method comprising:
receiving a charge-sharing enable signal and a data-transfer signal, the data-transfer signal comprising a plurality of data-transfer enable signals generated in sequence, and an interval existing between two adjacent data-transfer enable signals;
starting receiving the charge-sharing enable signal, and after at least a period of the interval, then a delay charge-sharing enable signal being output; and
voltage-level-shifting the voltage of the delay charge-sharing enable signal then outputting as a high-voltage charge-sharing enable signal to start the high-voltage output circuit.

19. The data driver starting-up current reduction method as claimed in claim 18, further comprises:
after the data-transfer signal has been received for at least a period of the interval, the data-transfer enable signal being output; and
the data-transfer enable signal being used to start the low-voltage circuit in the data driver.
